(19) United States
(12) Patent Application Publication
(10) Pub. No.: US 2014/0352834 A1
(43) Pub. Date: Dec. 4, 2014

(54) STIFFENER FOR FLEXIBLE HOSE

(71) Applicant: JAMES McLELLAN, NEW ORLEANS, LA (US)

(72) Inventor: JAMES McLELLAN, NEW ORLEANS, LA (US)

(21) Appl. No.: 13/909,594

(22) Filed: Jun. 4, 2013

(51) Int. Cl. F16L 11/10

(52) U.S. Cl. CPC F16L 11/10
USPC 138/172

(57) ABSTRACT

A hose stiffener consisting of multiple rods or strips to be oriented parallel to the axis of a hose connected to multiple partial rings to be oriented perpendicular to the hose, preferably molded or machined as a single piece, for use in water, salt water, chlorinated water, fluid, chemical and outdoor environments. The hose stiffener can be readily installed or retrofitted onto hoses by clipping the hose stiffener onto the hose to prevent tangling or knotting. The hose stiffener may be used to prevent tangling or knotting of existing swimming pool cleaner feeder hoses without restricting the movement of the swimming pool cleaner and does not have features that could injure people who might contact the hose stiffener while swimming in the pool. The hose stiffened may be used in other applications and other environments to prevent tangling or knotting of hoses.

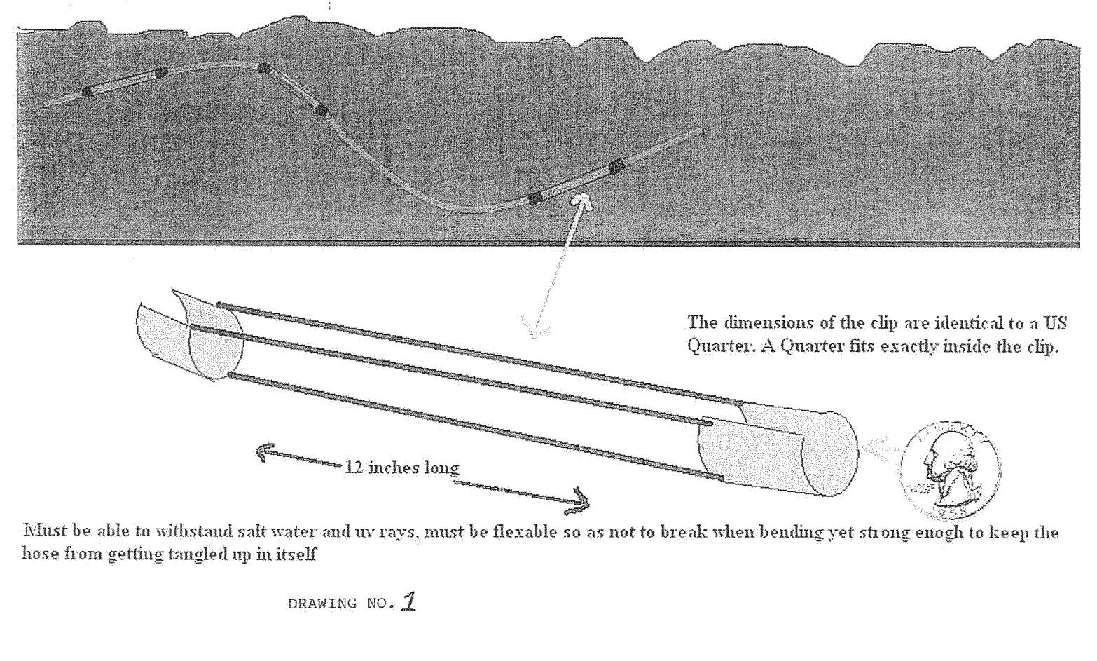

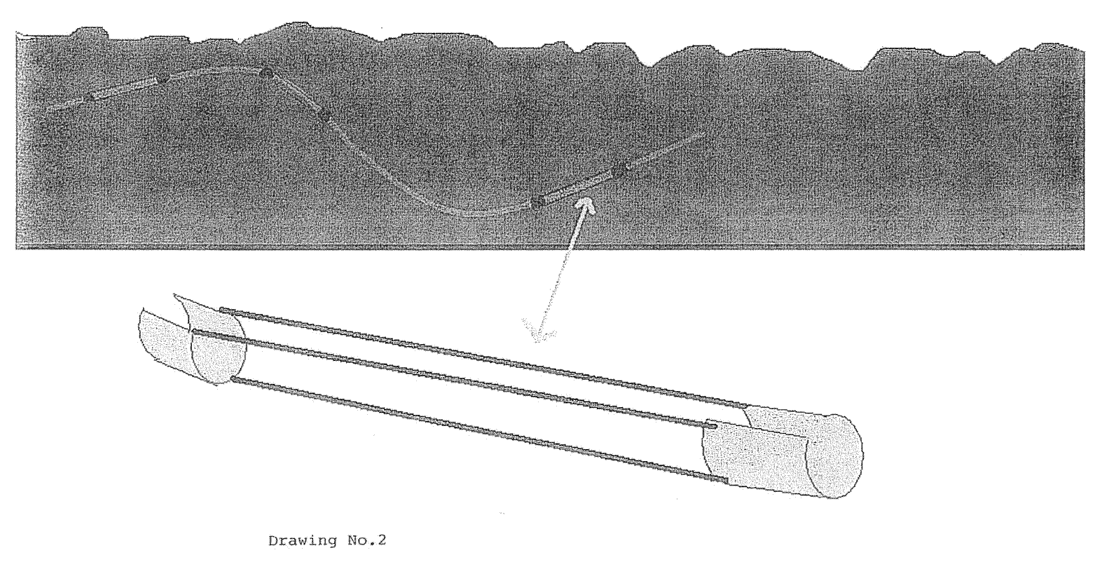

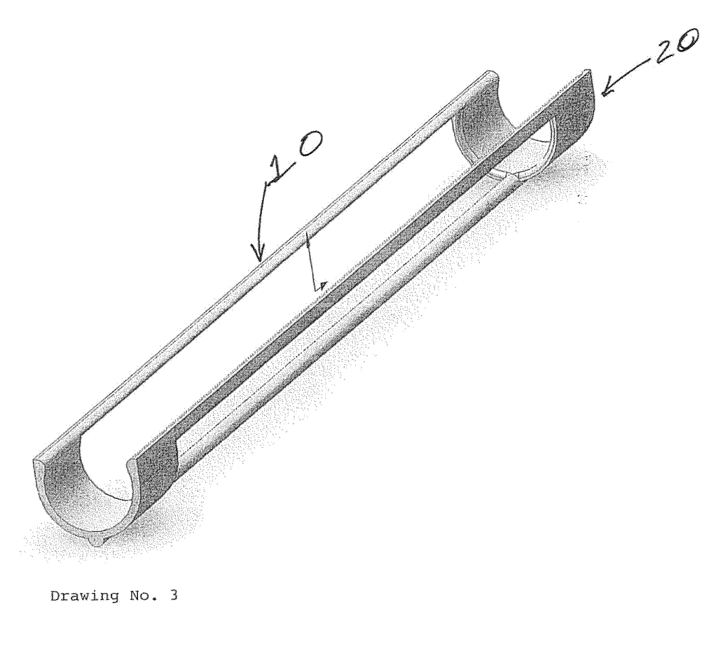

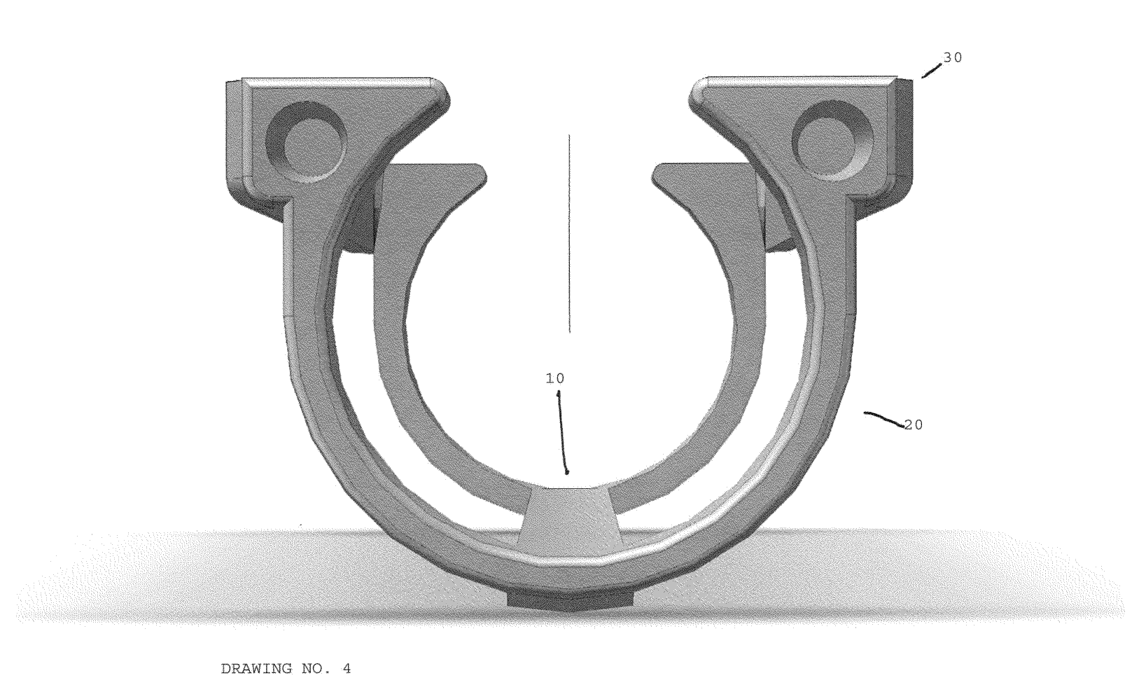

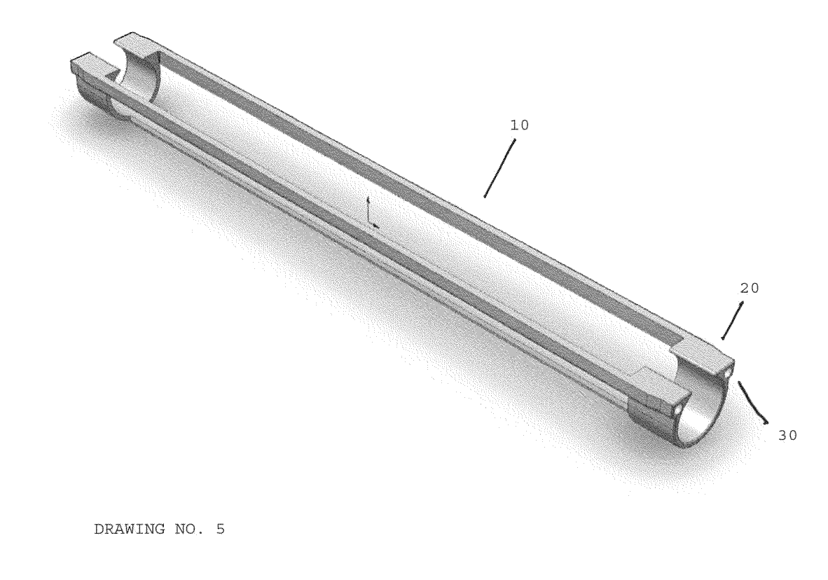

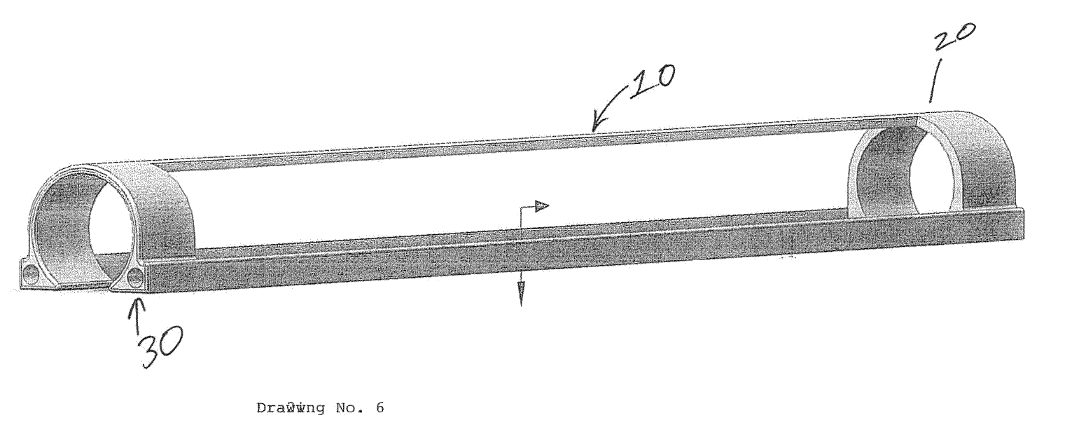

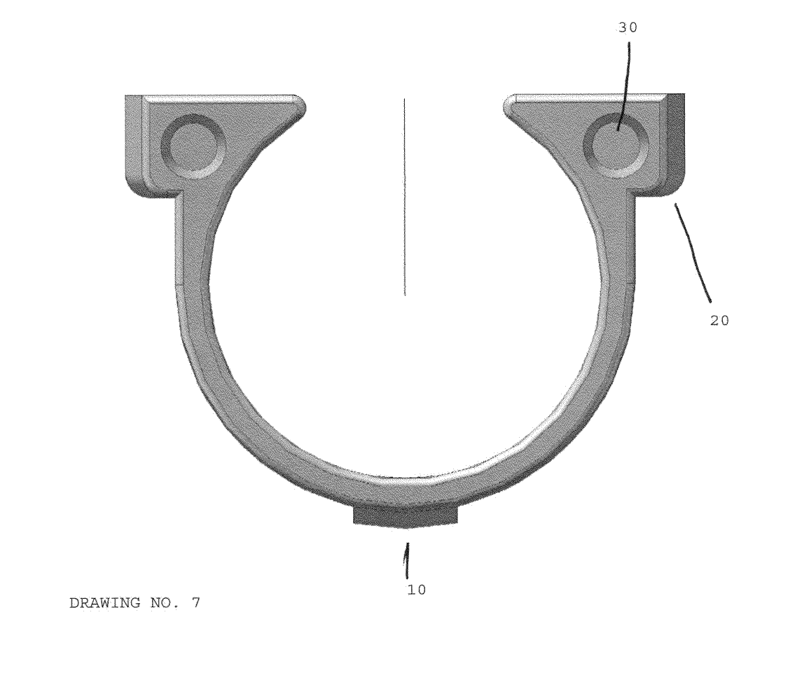

### PRIORITY

Priority is claimed based on U.S. Provisional Patent Application No. 61/655,568, filed on Jun. 5, 2012.

REFERENCES CITED

| | | |
|---|---|---|
| 2,881,804 | 4/59 | Bub |
| 3,936,899 | 2/76 | Henkin |
| 5,029,600 | 7/91 | McCullagh |
| 5,557,819 | 9/96 | Krolikowski |
| 5,893,188 | 4/99 | Campbell |
| 6,279,961 B1 | 8/01 | Stoltz |
| 7,145,074 B2 | 12/06 | Henkin |
| 7,213,287 B2 | 5/07 | Hui |
| 7,469,722 | 12/08 | Berland |
| 7,568,861 B2 | 4/09 | Godoy |
| 7,543,607 B2 | 6/09 | Henkin |
| 7,621,014 B2 | 11/09 | Katz |
| 7,690,066 | 4/10 | Stoltz |
| 7,786,381 B2 | 8/10 | Henkin |
| 7,862,712 B2 | 1/11 | Tak |
| 7,945,981 B2 | 5/11 | Lapping |
| 8,117,704 B2 | 2/12 | Schneider |

### BACKGROUND

1. Field of the Invention

The present invention relates to stiffeners for flexible hoses for use in water, salt water, chlorinated water, fluid, chemical and outdoor environments and more particularly to stiffeners for hoses for swimming pool cleaning equipment to prevent tangling of the pool cleaner hoses, and for related applications.

2. Description of the Related Art

Swimming pools require frequent cleaning to remove debris and material from the bottom and sides of the pool. Manual swimming pool cleaners that use water and vacuum to clean the pool surface have been used for many years. Improvements to the hoses for swimming pool cleaners have been previously developed. See e.g. Pool Cleaner With Weighted Hose, U.S. Pat. No. 5,557,819 (Krolikowski 1996).

Automatic swimming pool cleaners comprised of a cleaning assembly that moves along the bottom and sides of a swimming pool that is powered by water provided by a separate pump or by water from the swimming pool's pump have been in use for many years and are presently manufactured by several companies. See e.g. Automatic Swimming Pool Cleaner, U.S. Pat. No. 3,936,899 (Henkin 1976); Accessory Method and Apparatus tor Automatic Swimming Pool Cleaners, U.S. Pat. No. 5,029,600 (McCullagh 1991), Automatic Swimming Pool Cleaner, U.S. Pat. No. 5,893,188 (Campbell 1999); Swimming Pool Cleaner, U.S. Pat. No. 7,213,287 (Hui 2007); Automatic Pool Cleaner, U.S. Pat. No. 7,690,066 (Stoltz, 2010); Swimming Pool Cleaning System, U.S. Pat. No. 7,862,712 (Tak 2011); Swimming Pool Cleaner, U.S. Pat. No. 8,117,704 (Schneider 2012). These pool cleaners all require flexible hoses to deliver the water to the cleaning assembly, known as the “feed hose.” As the pool cleaner moves along the bottom of the pool, the feed hose frequently becomes tangled or knotted, which can result in the pool cleaner not cleaning the entire pool surface or becoming stuck in one location in the pool. Swimming pool cleaner feed hoses and hoses in other applications must be compatible with chlorinated or iodized water, pool cleaning and disinfectant compounds, salt water, sunlight and ultraviolet light and outdoor environments. The feeder hose must be light enough to not restrict the movement of the swimming pool cleaner. The feeder hose must also not have features that could injure people, as people often swim in the pool while the swimming pool cleaner and the feeder hose are in the swimming pool.

Prior approaches to address tangling and knotting of the feed hose have included rotatable hose couplings; feeder hoses with stiff sections. See e.g. Rotatable Hose Coupling, U.S. Pat. No. 6,279,961 (Stoltz 2001); Automatic Pool Cleaner Power Conduit Including Stiff Sections. U.S. Pat. No. 7,145,074 (Henkin 2006); Automatic Pool Cleaner Power Conduit Including Stiff Sections and Resilient Axially Flexible Couplers, U.S. Pat. No. 7,543,667 (Henkin 2009); Automatic Pool Cleaner Power Conduit Including Stiff Sections, U.S. Pat. No. 7,786,381 (Henkin 2010). In practice, these approaches have been not eliminated tangling or knotting of the feeder hose and require pool owners to purchase more expensive feeder hoses.

Another approach was to provide for microprocessor or electronic controls in the cleaner assembly to detect if the cleaner assembly has traveled in a circle and then reverse the cleaner assembly rotation to remove any twists or loops in the feeder hose. See Method for Controlling Twisting of Pool Cleaner Power Cable, U.S. Pat. No. 7,621,014 (Kate 2009). This approach significantly increases the cost of the cleaner assembly, due to requiring a water-tight microprocessor and electronic assemblies in the submerged cleaner assembly and more complicated mechanical components to drive the cleaner assembly.

A hose stiffener made of sheet metal or metallic rods with sheet metal flanges has been disclosed. See Hose Stiffener, U.S. Pat. No. 2,881,804 (Bub 1959). A metallic hose stiffener would not be compatible with chlorinated or iodized water, pool cleaning and disinfectant compounds, salt water, sunlight and ultraviolet light and outdoor environments. A stiffener made of several components would be overly expensive, heavy and not compatible with the swimming pool environment. See e.g. Segmented Bend Stiffener, U.S. Pat. No. 7,469,722 (Berland 2008); Bend Stiffener, U.S. Pat. No. 7,568,861 (Godoy 2009).

### SUMMARY

The present invention provides a hose stiffener that can be readily installed or retrofitted onto the feeder hoses of existing swimming pool cleaners to prevent tangling or knotting of the feeder hose and is compatible with chlorinated or iodized water, salt water and pool cleaning chemicals and disinfectants, sunlight and the outdoor environments.

The present invention provides a hose stiffener for a swimming pool cleaner feeder hose that is light enough to not restrict the movement of the swimming pool cleaner and does not have features that could injure people who might contact the hose stiffener while swimming in the pool.

The present invention provides a hose stiffener that can be readily installed or retrofitted onto hoses to prevent tangling or knotting and is compatible with fluid, chemical or outdoor environments.

In one embodiment of the present invention, a single piece hose stiffener comprising of rods or strips to be oriented parallel to the axis of a hose and two or more partial rings to be oriented perpendicular to the hose made of Acrylonitrile Butadiene Styrene thermoplastic (hereinafter “ABS”) or other material compatible with chlorinated water or other environments is provided that clips onto the hose to stiffen the feeder hose of a swimming pool cleaner to prevent tangling, or knotting of the feeder hose.

In another embodiment of the present invention, a single piece hose stiffener comprising of rods or strips to be oriented parallel to the axis of a hose and two or more partial rings to be oriented perpendicular to the hose made of ABS or other material compatible with chlorinated water or other environments is provided that clips onto the hose to stiffen the feeder hose of a swimming pool cleaner to prevent tangling or knotting of the feeder hose, with additional features permitting multiple hose stiffeners to be connected to one another to provide a longer stiffened hose section.

In another embodiment of the present invention, a single piece hose stiffener comprising of rods or strips to be oriented parallel to the axis of a hose and two or more partial rings to be oriented perpendicular to the hose made of ABS or other material compatible with fluid, chemical or outdoor environments is provided that clips onto the hose to stiffen the hose to prevent tangling or knotting of a hose.

In another embodiment of the present invention, a single piece hose stiffener comprising of rods or ships to be oriented parallel to the axis of a hose and two or more partial rings to be oriented perpendicular to the hose made of ABS or other material compatible with fluid, chemical or outdoor environments is provided that clips onto the hose to stiffen the hose to prevent tangling or knotting of a hose, with additional features permitting multiple hose stiffeners to be connected to one another to provide longer stiffened hose sections.

In another embodiment of the present invention, the partial rings are flexible enough to snap onto the hose and retain the hose, as well as being removable from the hose when desired, which is achieved by the width of the open space of the partial ring being approximately 50 percent of the diameter of the hose, the partial ring being sufficiently flexible to be opened for the hose to be placed inside the partial ring, and the partial ring having edges of the open space that act like tongs to hold the hose in place.

In another embodiment of the present invention, additional clips, fasteners, tabs, pins, hooks, loops, screws, latches or other securing means could be provided to further secure the hose stiffener to the pool cleaner feeder hose or other hose.

### DESCRIPTION OF THE DRAWINGS¹

Drawing No. 1 illustrates an embodiment of the present invention, showing the longitudinal rods or strips and the perpendicular partial rings, sized to clip onto the feeder hose typically used by swimming pool cleaners, and the use of the invention underwater on the swimming pool cleaner feeder hose. ¹Applicant reserves the right to substitute formal drawings via amendment or after receiving notice of allowability.

Drawing No. 2 illustrates an embodiment of the present invention, showing the longitudinal rods or strips and the perpendicular partial rings, sized to clip onto a hose, and the use of the invention in a fluid environment on a hose.

Drawing No. 3 is a diagonal view of an embodiment of the present invention, showing the longitudinal rods of strips (Item 10) and the perpendicular partial rings (Item 20).

Drawing No. 4 is end view of an embodiment of the present invention, showing the longitudinal rods or strips and the perpendicular partial rings.

Drawing No. 5 is a diagonal view of an embodiment of the present invention, showing the longitudinal rods or strips and the perpendicular partial rings and additional features (Item 30) that could be used to connect multiple hose stiffeners to each other.

Drawing No. 6 is side view of an embodiment of the present invention, showing the longitudinal rods or strips and the perpendicular partial rings and additional features that could be used to connect multiple hose stiffeners to each other.

Drawing No. 7 is end view of an embodiment of the present invention, showing the longitudinal rods or strips and the perpendicular partial rings and additional features that could be used to connect multiple hose stiffeners to each other.

### DETAILED DESCRIPTION

The present invention, entitled Stiffener for Flexible Hose, is a hose stiffener for use with flexible hoses for use in water, salt water, chlorinated water, fluid, chemical and/or outdoor environments and more particularly to stiffeners for hoses for swimming pool cleaning equipment to prevent tangling and knotting of the pool cleaner hoses, and for related applications. The present invention provides a hose stiffener that can be readily installed or retrofitted onto hoses to prevent tangling or knotting and is compatible with fluid, chemical or outdoor environments.

The present invention, in one preferred embodiment is a single piece hose stiffener machined or molded of ABS or other polymeric materials or other materials, comprising multiple rods or strips to be oriented parallel to the axis of a hose (Item 10 in drawings) and two or more partial rings to be oriented perpendicular to the hose (Item 20 in drawings). The hose stiffener of the present invention may also include additional features to connect multiple hose stiffeners to each other (Item 30 in drawings). The hose stiffener of the present invention may be sized to fit onto existing feeder hoses for swimming pool cleaners or may be sized to fit onto other hoses. The hose stiffener of the present invention may also be assembled of multiple rods or strips and partial or complete rings by a variety of manufacturing methods. The hose stiffener of the present invention may be comprised of various materials to be compatible with the fluid or other environments for the desired use.

The present invention in the preferred embodiment consists of three strips or rods to be oriented parallel to the hose and two partial rings, as illustrated in the drawings. More than three rods or strips could be used to provide additional stiffness. More than two partial rings could be used to provide additional stiffness and for longer stiffeners.

The present invention in the preferred embodiment comprises partial rings of dimensions, features, design and construction to readily clip onto a hose of the intended size and remain clipped onto the hose, without the need for fasteners or other securing means.

Although applicant has disclosed a number of embodiments herein, it should be understood that many other variations and modifications are possible without departing from the scope and spirit of the present invention as defined by the appended claims. Accordingly, no limitation on the invention is intended by way of the description and drawings, except as set forth in the appended claims.

I claim:

1. A stiffener for flexible hose of substantially the same diameter as the inside of the stiffener, comprising multiple rods or strips to be oriented parallel to the axis of a hose connected to two or more partial rings to be oriented perpendicular to the hose.

2. The stiffener for flexible hose of claim 1, where said rods or strips and said partial rings are molded, machined or manufactured as a single piece.

3. The stiffener for flexible hose of claim 1, where said rods or strips and said partial rings are made of Acrylonitrile Butadiene Styrene thermoplastic (hereinafter “ABS”) or other material compatible with chlorinated water or other environments.

4. The stiffener for flexible hose of claim 1, where said partial rings have an opening to permit the hose to pass between said partial rings.

5. The stiffener for flexible hose of claim 1, where said partial rings are of dimensions, features, design and construction to readily clip onto a hose of the intended size and remain clipped onto the hose, without the need for fasteners or other securing means.

6. The stiffener for flexible hose of claim 1, comprising three rods or strips to be oriented parallel to the axis of a hose connected to two partial rings to be oriented perpendicular to the hose.

7. The stiffener for flexible hose of claim 6, where said rods or strips and said partial-rings are molded, machined or manufactured as a single piece.

8. The stiffener for flexible hose of claim 6, where said rods or strips and said partial rings are made of Acrylonitrile Butadiene Styrene thermoplastic (hereinafter “ABS”) or other material compatible with chlorinated waver or other environments.

9. The stiffener for flexible hose of claim 6, where said partial rings have an opening to permit the hose to pass between said partial rings.

10. The stiffener for flexible hose of claim 6, where said partial rings are of dimensions, features, design and construction to readily clip onto a hose of the intended size and remain clipped onto the hose, without the need for fasteners or other securing means.

11. A stiffener for flexible hose of substantially the same diameter as the inside of the stiffener, comprising multiple rods or strips to be oriented parallel to the axis of a hose connected to two or more partial rings to be oriented perpendicular to the hose, with additional securing means to further secure the hose stiffener to the hose.

12. A stiffener for flexible hose of substantially the same diameter as the inside of the stiffener, comprising multiple rods or strips to be oriented parallel to the axis of a hose connected to two or more partial rings to be oriented perpendicular to the hose and additional securing means or features to be connect to one hose stiffener to one or more other hose stiffeners.

13. A stiffener for flexible hose of substantially the same diameter as the inside of the stiffener, comprising multiple rods or strips to be oriented parallel to the axis of a hose connected to two or more partial rings to be oriented perpendicular to the hose, said hose stiffener being sized to clip onto the feeder hoses of existing swimming pool cleaners and of made of materials compatible with chlorinated water, iodized water, salt water, sunlight and outdoor environments.

14. A stiffener for flexible hose of substantially the same diameter as the inside of the stiffener, comprising multiples rods or strips to be oriented parallel to the axis of a hose connected to two or more partial rings to be oriented perpendicular to the hose for use with the feeder hose of swimming pool cleaners, said hose stiffener not having sharp edges, corners, pointed sections or other features that could injure people who might contact the hose stiffener while swimming in the pool.

15. A stiffener for flexible hose, comprising multiple rods or strips to be oriented parallel to the axis of a hose connected to two or more partial rings to be oriented perpendicular to the hose, said partial rings being flexible enough to snap onto the hose and retain the hose, as well as being removable from the hose when desired, where the width of the open space of the partial rings is approximately 50 percent of the diameter of the hose, and the partial rings having edges of the open space that act like tongs to hold the hose in place.
